(19) United States
(12) Patent Application Publication
(10) Pub. No.: US 2021/0325810 A1
(43) Pub. Date: Oct. 21, 2021

(54) IMAGE FORMING DEVICE, GLOSS MEASURING METHOD, AND PROGRAM

(71) Applicant: KONICA MINOLTA, INC., Tokyo (JP)

(72) Inventors: Akimasa ISHIKAWA, Toyokawa-shi (JP); Atsushi TAKAHASHI, Tokyo (JP); Hitoshi ASANO, Toyokawa-shi (JP); Yumiko IZUMIYA, Tokyo (JP); Hirotada SEKI, Toyokawa-shi (JP)

(73) Assignee: KONICA MINOLTA, INC., Tokyo (JP)

(21) Appl. No.: 17/218,634

(22) Filed: Mar. 31, 2021

(30) Foreign Application Priority Data
Apr. 17, 2020 (JP) 2020-073823

(51) Int. Cl. G03G 15/00

(52) U.S. Cl. CPC G03G 15/6585

(57) ABSTRACT

The present invention is directed to detect gloss of a toner image from which the influence of heat applied to a sheet by a fixing unit is eliminated. An image forming device according to an aspect of the invention includes: a gloss sensor irradiating a recording medium on which a toner image is formed and fixed with light, measuring reflectance of reflection light from the recording medium, and measuring gloss of the toner image on the basis of the reflectance; and a gloss correcting unit correcting the gloss of the toner image measured by the gloss sensor in a situation that the temperature of the toner image fixed on the recording medium is assumed to be higher than a predetermined threshold temperature or in the case where it is determined that the temperature of the toner image is higher than the predetermined threshold temperature.

### CROSS-REFERENCE TO RELATED APPLICATIONS

The entire disclosure of Japanese Patent Application No. 2020-73823, filed on Apr. 17, 2020, is incorporated herein by reference in its entirety.

### BACKGROUND

### Technological Field

The present invention relates to an image forming device, a gloss measuring method, and program.

### Description of the Related Art

In an image forming device, it is important to maintain the gloss of an image (toner image) formed (printed) on a sheet (an example of a recording medium) constant. Consequently, in an image forming device, the gloss of an image printed on a sheet is measured by a gloss sensor or the like.

Japanese Patent No. 5932730 (Patent literature 1) discloses a technique of disposing a gloss sensor at an ejection port of a recording medium subjected to fixing by a fixing unit or in a carriage path between the ejection port and the fixing unit and, on the basis of a measurement value of a toner image and the gloss of a part which is not an image by the gloss sensor, setting fixing conditions of the fixing unit.

### RELATED ART LITERATURE

### Patent Literature

Patent Literature 1: Japanese Patent No. 5932730

### SUMMARY

The gloss of a toner image detected by a gloss sensor changes in a process that a sheet on which an image is fixed by a fixing unit in an image forming device is cooled with time. Concretely, the gloss of a toner image detected in a state where the temperature of the sheet which immediately after passes through a fixing unit is high is lower than that of the image detected after the heat of the sheet decreases.

Therefore, the technique described in the patent literature 1 has the possibility that the gloss of a toner image on a sheet whose temperature is still high is measured depending on the position where the gloss sensor is disposed and the gloss lower than the real gloss is measured.

The present invention has been achieved in consideration of such conditions and an object of the present invention is to provide an image forming device, a gloss measuring method, and a program capable of detecting the gloss of a toner image from which the influence of heat applied to a sheet by a fixing unit is eliminated.

To achieve the object, an image forming device in which an aspect of the present invention is reflected includes: a gloss sensor irradiating a recording medium on which a toner image is formed and fixed with light, measuring reflectance of reflection light from the recording medium, and measuring gloss of the toner image on the basis of the reflectance; and a gloss correcting unit correcting the gloss of the toner image measured by the gloss sensor in a situation that the temperature of the toner image fixed on the recording medium is assumed to be higher than a predetermined threshold temperature or in the case where it is determined that the temperature of the toner image is higher than the predetermined threshold temperature.

A gloss measuring method in which an aspect of the present invention is reflected is a gloss measuring method by an image forming device having a gloss sensor and a gloss correcting unit and includes: a step of causing the gloss sensor to irradiate, with light, a recording medium on which a toner image is formed and fixed, to measure reflectance of reflection light from the recording medium, and to measure gloss of the toner image on the basis of the reflectance; and a step of causing the gloss correcting unit to correct the gloss of the toner image measured by the gloss sensor, in a situation that the temperature of the toner image fixed on the recording medium is assumed to be higher than a predetermined threshold temperature or in the case where it is determined that the temperature of the toner image is higher than the predetermined threshold temperature.

A program in which an aspect of the present invention is reflected is a program executed by an image forming device having a gloss sensor and a gloss correcting unit, and causes the gloss sensor to irradiate with light, a recording medium on which a toner image is formed and fixed, to measure reflectance of reflection light from the recording medium, and to measure gloss of the toner image on the basis of the reflectance; and causes the gloss correcting unit to correct the gloss of the toner image measured by the gloss sensor, in a situation that the temperature of the toner image fixed on the recording medium is assumed to be higher than a predetermined threshold temperature or in the case where it is determined that the temperature of the toner image is higher than the predetermined threshold temperature.

According to the present invention, an image forming device, a gloss measuring method, and a program capable of detecting gloss of a toner image from which the influence of heat applied to a sheet by a fixing unit is eliminated are provided. The other objects, configuration, and effects will become apparent from the following description of the embodiments.

### BRIEF DESCRIPTION OF THE DRAWINGS

The advantages and features provided by embodiments of the invention will become more fully understood from the detailed description given hereinbelow and the appended drawings which are given by way of illustration only, and thus are not intended as a definition of limits of the present invention.

FIG. 1 is a graph illustrating reflectance obtained when a toner image on a sheet which passed through a fixing unit is read by a gloss sensor and changes in toner image temperature according to an embodiment of the present invention.

FIG. 2 is a schematic diagram illustrating an example of a general configuration of an image forming device according to an embodiment of the present invention.

FIG. 3 is a block diagram illustrating a configuration example of a control system of the image forming device according to an embodiment of the invention.

FIG. 4 is a diagram illustrating a configuration example of a gloss sensor according to an embodiment of the present invention.

FIG. 5 is a table illustrating a configuration example of a reflectance-toner image prediction temperature table according to an embodiment of the present invention.

FIG. 6 is a diagram illustrating a configuration example of a toner image prediction temperature-correction value table according to an embodiment of the present invention.

FIG. 7 is a flowchart illustrating an example of the procedure of a gloss measuring method by an image forming device according to an embodiment of the present invention.

FIG. 8 is a diagram illustrating a configuration example of a fixing temperature-elapse time-correction value table according to Modification 2.

FIG. 9 is a diagram illustrating a configuration example of a sheet type-correction value table according to Modification 3.

FIG. 10 is a diagram illustrating a configuration example of a gloss sensor in which a photosensitive element is a linear sensor, according to Modification 4.

FIG. 11 is a graph illustrating correspondence between reflectance of reflection light detected by a photosensitive element of a gloss sensor and detection angle, according to Modification 4.

FIG. 12 is a diagram illustrating correspondence between the reflectance of the reflection light detected by the photosensitive element and detection angle in the case where toner image temperature varies according to Modification 4.

FIG. 13 is a table illustrating a configuration example of a detection value-toner image prediction temperature table according to Modification 4.

FIG. 14 is a diagram illustrating a configuration example of a toner image prediction temperature-correction value table according to Modification 4.

FIG. 15 is a diagram illustrating a configuration example of a fixing temperature-elapse time-correction value table according to Modification 5.

FIG. 16 is a diagram illustrating a sheet type-correction value table according to Modification 6.

### DETAILED DESCRIPTION OF EMBODIMENTS

Hereinafter, embodiments for carrying out the present invention will be described with reference to the appended drawings. However, the scope of the invention is not limited to the embodiments. In the specification and the drawings, the same reference numerals are designated to components having substantially the same function or configuration and repetitive description of the components will be omitted. First, prior to description of configuration examples of various embodiments, the problem to be solved in the present invention will be described more concretely.

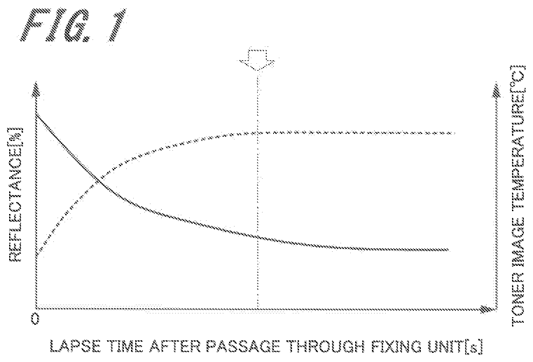

FIG. 1 is a graph illustrating reflectance obtained when a toner image on a sheet passed through a fixing unit is read by a gloss sensor and changes in toner image temperature. The vertical axes of the graph of FIG. 1 indicate reflectance (%) and toner image temperature (° C.), and the horizontal axis indicates elapse time (s) after passage through a fixing unit. In FIG. 1, the change in the reflectance is illustrated by the broken line, and the change in toner image temperature is illustrated by the solid line.

As illustrated in the graph of FIG. 1, immediately after passage through the fixing unit, the reflectance of a toner image is low. The reflectance becomes higher as the elapse time after passage through the fixing unit becomes longer. Since the composition of toners forming the toner image is not stable immediately after passage through the fixing unit, the diffusion directions of reflection light emitted from a light source and reflected by the toner image are various. Therefore, the reflectance detected is also low. However, as the elapse time after passage through the fixing unit becomes longer and the temperature of the toner image becomes lower, the composition of the toner becomes stable and the reflectance becomes higher. By measuring the gloss of the toner image in such a state, the real gloss of the toner image is detected.

It is therefore desirable to detect and measure the gloss of a toner image at or after the timing when the temperature of a toner image becomes equal to or less than a predetermined temperature and the reflectance (gloss) becomes stable, which is indicated by the alternate long and short dash line in the diagram.

### Schematic Configuration of Image Forming Device

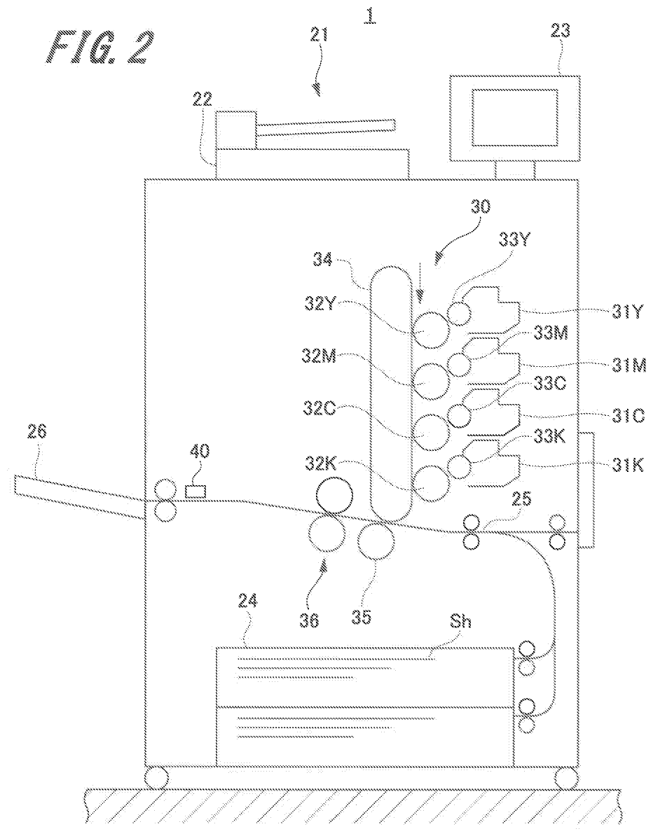

Referring now to FIG. 2, the general configuration of an image forming device 1 according to an embodiment of the present invention will be described. FIG. 2 is a schematic diagram illustrating an example of the general configuration of the image forming device 1. The image forming device 1 includes, as illustrated in FIG. 2, an original reading unit 21 having an Auto Document Feeder (ADF) 22, an operation display unit 23, and a sheet ejection tray 26.

The original reading unit 21 optically reads an image from an original on an original feed stand of the ADF 22 and A/D converts the read image to generate image data (scan data).

The operation display unit 23 is constructed by a touch panel obtained by laying a touch sensor as an operation input unit on a display part made by an LCD (Liquid Crystal Display), an organic EL (Electro Luminescence) display, or the like. Although an example that the display unit and the operation input unit are integrally formed is mentioned in the embodiment, the present invention is not limited to the example. The operation input unit made by buttons, keys, or the like and the display unit made by an LCD or the like may be configured separately from each other.

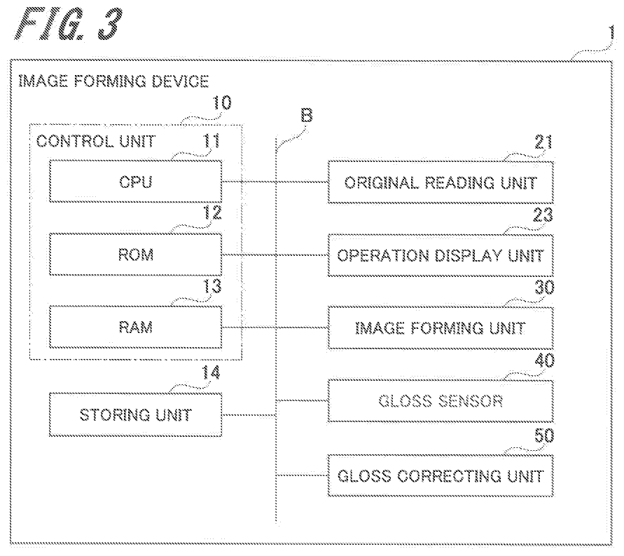

The operation display unit 23 generates an operation signal expressing the content of an operation from the user, which is entered to the operation unit and supplies the operation signal to a control unit 10 (refer to FIG. 3). For example, when an operation instructing start of an image forming process is entered by the user, the operation display unit 23 generates a signal to start the image forming process and supplies it to the control unit 10. For example, the operation display unit 23 displays the content of the operation, setting information, or the like by the user on the display unit on the basis of a display signal supplied from the control unit 10.

The sheet ejection tray 26 is a tray to which a sheet on which an image is formed by the image forming device 1 is ejected.

The image forming device 1 also has a sheet feed tray 24, a carriage path 25, an image forming unit 30, and a gloss sensor 40.

The sheet feed tray 24 is a container housing a sheet Sh on which image formation is performed by the image forming unit 30. Although FIG. 2 illustrates an example that there are two sheet feed trays 24, the present invention is not limited to the example. The number of sheet trays 24 may be one or three or more.

The carriage path 25 carries the sheet Sh fed from the sheet feed tray 24 to the sheet ejection tray 26. The carriage path 25 is provided with a plurality of rollers (carriage rollers) for carrying the sheet Sh. Although FIG. 2 illustrates a configuration of the case where the carriage path 25 does not have a path and a mechanism for double-sided printing, the present invention is not limited to the configuration. The present invention may be applied to an image forming device having a path and a mechanism for double-sided printing.

The image forming unit 30 has four image formation units 31Y, 31M, 31C, and 31K for forming toner images of colors of Y (yellow), M (magenta), C (cyan), and K (black), respectively. The image formation units 31Y, 31M, 31C, and 31K have charging units and LED writing units (laser light sources) (which are not illustrated), photoconductive drums 32Y, 32M, 32C, and 32K and developing units 33Y, 33M, 33C, and 33K, respectively.

The developing units 33Y, 33M, 33C, and 33K form latent images on the surface (outer peripheral parts) of the photoconductive drums 32Y, 32M, 32C, and 32K and make toners supplied from not-illustrated developers adhered to the latent images. As a result, toner images are formed on the photoconductive drums 32Y, 32M, 32C, and 32K.

In the following description, in the case where it is unnecessary to distinguish the image formation units 31Y, 31M, 31C, and 31K from one another, they will be collectively called the image formation units 31. In the case where it is unnecessary to distinguish the photoconductive drums 32Y, 32M, 32C, and 32K from one another, they will be collectively called the photoconductive drums 32. Further, in the case where it is unnecessary to distinguish the developing units 33Y, 33M, 33C, and 33K from one another, they will be collectively called the developing units 33.

The image forming unit 30 includes an intermediate transfer belt 34, a secondary transfer unit 35, and a fixing unit 36. The intermediate transfer belt 34 is a belt on which toner images formed on the photoconductive drums 32 of the respective colors are primary-transferred and rotates in the direction indicated by the downward arrow in the diagram. The secondary transfer unit 35 is a roller which secondary-transfers the toner images of the respective colors which are primary-transferred to the intermediate transfer belt 34 to the sheet Sh carried on the carriage path 25.

The fixing unit 36 is provided downstream of the placement position of the secondary transfer unit 35 in the carriage path 25 and performs a fixing process of fixing the toner image transferred to the sheet Sh by the secondary transfer unit 35 on the sheet Sh. The process of fixing a toner image by the fixing unit 36 is performed by pressing the sheet Sh on which the toner image is transferred by a not-illustrated roller and heating it.

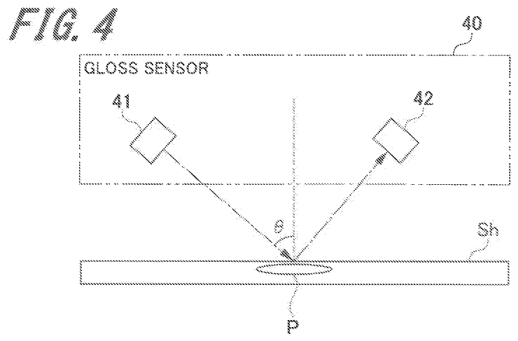

The gloss sensor 40 is disposed near the sheet ejection tray 26 downstream of the fixing unit 36. The gloss sensor 40 includes a light source 41 and a photosensitive element 42 (refer to FIG. 4) and a computing unit (not illustrated). The light source 41 irradiates the sheet Sh on which a toner image is fixed with light. The photosensitive element 42 receives reflection light emitted from the light source 41 and reflected by the toner image fixed surface of the sheet Sh and calculates the reflectance. The computing unit calculates the gloss of each of the colors on the basis of the reflectance calculated by the photosensitive element 42. The sheet Sh subjected to the gloss measurement by the gloss sensor 40 is carried over the carriage path 25 and ejected to the sheet ejection tray 26.

Configuration of Control System of Image Forming Device Referring now to FIG. 3, the configuration of the control system of the image forming device 1 according to an embodiment of the present invention will be described. FIG. 3 is a block diagram illustrating a configuration example of the control system of the image forming device 1.

As illustrated in FIG. 3, the image forming device 1 includes the control unit 10, a storage unit 14, the original reading unit 21, the operation display unit 23, the image forming unit 30, the gloss sensor 40, and a gloss correcting unit 50.

The control unit 10 includes, for example, a CPU (Central Processing Unit) 11, a ROM (Read Only Memory) 12 for storing a program or the like which is executed by the CPU 11, and a RAM (Random Access Memory) 13 used as a work area of the CPU 11.

The CPU 11 is connected to the units constructing the image forming device 1 via a system bus B. By communicating with those units connected via the system bus B, the CPU 11 controls the operations of the units.

For example, the CPU 11 controls the image forming unit 30 to form an image on the sheet Sh carried on the carriage path 25 (refer to FIG. 2). The CPU 11 controls the gloss sensor 40 to detect the gloss of the toner image formed and fixed on the sheet Sh. Further, the CPU 11 controls the gloss correcting unit 50 to correct the gloss measured by the gloss sensor 40.

The RAM 13 temporarily stores data or the like necessary for the CPU 11 to execute a program. The ROM 12 is constructed by a nonvolatile memory such as a semiconductor memory or the like and stores a system program corresponding to the image forming device 1 and various programs which can be executed on the system program. The program stored in the ROM 12 is stored in the form of a computer-readable program code and the CPU 11 sequentially executes operations according to the program code.

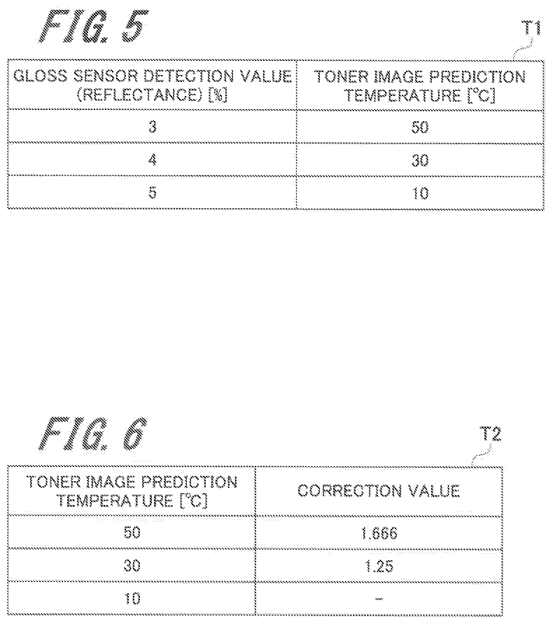

The storing unit 14 is constructed by, for example, an HDD (Hard Disk Drive), an SSD (Solid State Drive) or the like and stores a reflection-toner image prediction temperature table T1 (refer to FIG. 5) used by the gloss correcting unit 50 for correction of reflectance, a toner image prediction temperature-correction value table T2 (refer to FIG. 6), and the like. Alternately, the reflectance-toner image prediction temperature table T1 and the toner image prediction temperature-correction value table T2 may be stored in the ROM 12, not in the storing unit 14.

Since the original reading unit 21, the operation display unit 23, and the image forming unit 30 have been described with reference to FIG. 2, their description will not be repeated here. The details of the configuration of the gloss sensor 40 will be described specifically with reference to FIG. 4 to be described later.

The gloss correcting unit 50 predicts the temperature of a toner image on the basis of a detection value of the gloss sensor 40 and, when the prediction temperature of the toner image is higher than a predetermined threshold temperature, corrects the detection value (gloss) obtained by the gloss sensor 40. Concretely, the gloss correcting unit 50 predicts the temperature of a toner image with reference to the reflectance-toner image prediction temperature table T1 (refer to FIG. 5) and determines a correction value with reference to the toner image prediction temperature-correction value table T2 (refer to FIG. 6). Using the determined correction value, the gloss correcting unit 50 corrects the detection value (gloss) of the gloss sensor 40.

### Configuration of Gloss Sensor

Referring now to FIG. 4, the configuration of the gloss sensor 40 will be described. FIG. 4 is a diagram illustrating a configuration example of the gloss sensor 40. As illustrated in FIG. 4, the gloss sensor 40 includes the light source 41 and the photosensitive element 42. The light source 41 is made by, for example, an LED (Light Emitting Diode) or the like and irradiates the toner image P formed on the surface of the sheet Sh as an object to be measured. The photosensitive element 42 is made by, for example, a PD (Photo Diode) or the like, receives reflection light emitted from the light source 41 and reflected by the sheet Sh, and calculates reflectance on the basis of the received light amount.

The not-illustrated computing unit calculates gloss on the basis of the reflectance calculated by the photosensitive element 42. The gloss can be calculated, using a black mirror-plane glass as a reference, on the basis of the relation between specular reflectivity of the glass plate and incident angle θ in the case where the specular gloss of the specular reflectivity at a specified incidence angle θ is defined as “100”.

### Configuration of Reflectance-Toner Image Prediction Temperature Table

Referring now to FIG. 5, the configuration of the reflectance-toner image prediction temperature table T1 which is referred to by the gloss correcting unit 50 at the time of correction of gloss will be described. FIG. 5 is a table illustrating a configuration example of the reflectance-toner image prediction temperature table T1. As illustrated in FIG. 5, the reflectance-toner image prediction temperature table T1 has fields of “gloss sensor detection value (reflectance) [%]” and “toner image prediction temperature [° C.]”.

In the field of “gloss sensor detection value (reflectance) [%]”, the reflectance (%) as the detection value of the gloss sensor 40 is stored. In the field of “toner image prediction temperature [° C.]”, the temperature (prediction temperature) of the toner image P predicted on the basis of the reflectance detected by the gloss sensor 40 is stored.

The reflectance-toner image prediction temperature table T1 illustrates correspondence between reflectance and toner image prediction temperature in the case where reflectance detected at the timing when the state (composition) of a toner becomes stable, which is indicated by the alternate long and short dash line in the graph of FIG. 1 is “5%” and toner image temperature is “10° C.”.

Concretely, as illustrated in the record of the lowest line in the reflectance-toner image prediction temperature table T1, “10° C.” of the toner image prediction temperature is associated with “5%” as the detection value of the gloss sensor 40.

In the record of the uppermost line in the reflectance-toner image prediction temperature table T1, “50° C.” as the toner image prediction temperature is associated with “3%” of the reflectance detected by the gloss sensor 40, and “30° C.” as the toner image prediction temperature is associated with “4%” of the reflectance in the second highest record.

On the basis of the reflectance-toner image prediction temperature table T1, the gloss correcting unit 50 predicts that the temperature of the toner image P is “50° C.” when the detection value (reflectance) of the gloss sensor 40 is “3%”, and predicts that the temperature of the toner image P is “30° C.” in the case where the detection value is “4%”. In the case where the detection value is “5%”, the gloss correcting unit 50 predicts that the temperature of the toner image P is “10° C.”.

### Configuration of Toner Image Prediction Temperature-Correction Value Table

Referring now to FIG. 6, the configuration of the toner image prediction temperature-correction value table T2 which is referred to when the gloss correcting unit 50 corrects gloss will be described. FIG. 6 is a diagram illustrating a configuration example of the toner image prediction temperature-correction value table T2.

As illustrated in FIG. 6, the toner image prediction temperature-correction value table T2 has fields of “toner image prediction temperature [° C.]” and “correction value”. In the field of “toner image prediction temperature [° C.]”, the temperature (prediction temperature) of the toner image P predicted on the basis of the reflectance detected by the gloss sensor 40 is stored. In the field of “correction value”, coefficient (correction value) which is multiplied by the detection value of the gloss sensor 40 is stored.

In the toner image prediction temperature-correction value table T2, the correction value “1.666” is associated with “50° C.” of “toner image prediction temperature [° C.], and the correction value “1.25” is associated with “30° C.”. No correction value is associated with “10° C.” of “toner image prediction temperature [° C.].

On the basis of the toner image prediction temperature-correction value table T2, in the case where the toner image prediction temperature is “50° C.”, the gloss correcting unit 50 corrects gloss by multiplying the detection value (reflectance) of the gloss sensor 40 by “1.666”. In the case where the toner image prediction temperature is “30° C.”, the gloss correcting unit 50 corrects gloss by multiplying the detection value (reflectance) of the gloss sensor 40 with “1.25”. In the case where the toner image prediction temperature is “10° C.”, the gloss correcting unit 50 does not correct gloss. That is, the gloss is calculated on the basis of the detection value of the gloss sensor 40.

The correction based on the reflectance-toner image prediction temperature table T1 and the toner image prediction temperature-correction value table T2 is made by the gloss correcting unit 50 and, for example, in the case where the reflectance detected by the gloss sensor 40 is 3%, it is assumed that the prediction temperature of the toner image P is “50° C.”, and the reflectance of “3%” is multiplied by “1.666”. That is, the reflectance detected by the gloss sensor 40 is corrected to 3%×1.666=about 5%.

For example, in the case where the reflectance detected by the gloss sensor 40 is 4%, the prediction temperature of the toner image P is assumed as “30° C.”, and the reflectance of “4%” is multiplied with “1.25”. That is, the reflectance detected by the gloss sensor 40 is corrected to 4%×1.25=5%.

That is, according to the embodiment, also in the case where gloss lower than assumed gloss is detected due to the fact that cooling of the sheet Sh after passage through the fixing unit 36 is insufficient, the detection value of the gloss sensor 40 is corrected by the gloss correcting unit 50 on the basis of toner image prediction temperature assumed on the basis of the detection value of the gloss sensor 40. Concretely, in the case where the toner image prediction temperature is higher than a predetermined threshold temperature (10° C. or the like), the detection value of the gloss sensor 40 is corrected by the gloss correcting unit 50. By the operation, the gloss detected by the image forming device 1 can be made almost the same as the real gloss detected in a state where the composition of the toner is stable since the toner image P is sufficiently cooled.

The reflectance and the toner image prediction temperature illustrated in the reflectance-toner image prediction temperature table T1 of FIG. 5 and the correction values and the like illustrated in the toner image prediction temperature-correction value table T2 of FIG. 6 are just an example, and it is assumed that optimum values obtained based on an experiment and the like are set as those values.

### Gloss Measuring Method by Image Forming Device

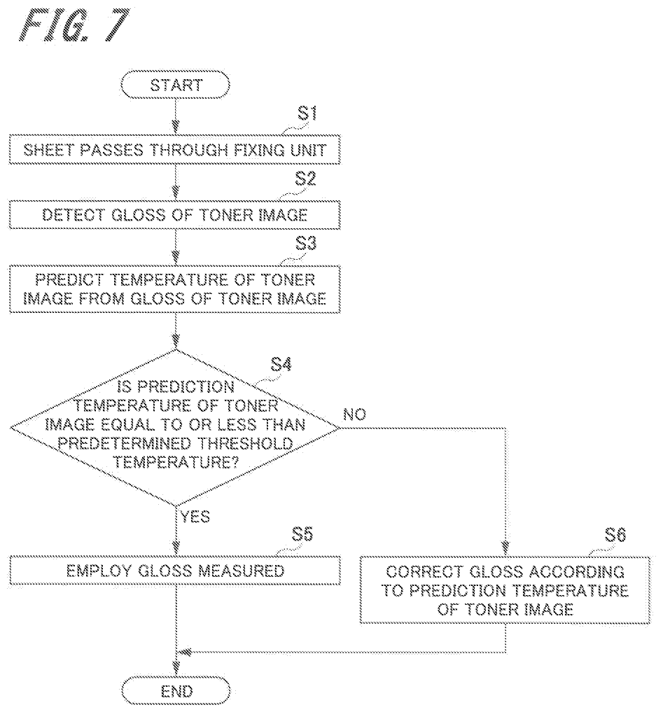

Referring now to FIG. 7, a gloss measuring method by the image forming device 1 according to the embodiment will be described. FIG. 7 is a flowchart illustrating an example of the procedure of a gloss measuring method by the image forming device 1.

First, the sheet Sh on which the toner image P is formed and the fixing process is performed by the fixing unit 36 passes through the fixing unit 36 (step S1). Subsequently, the gloss sensor 40 disposed downstream of the fixing unit detects the gloss (reflectance) of the toner image P on the sheet Sh (step S2). Then, the gloss correcting unit 50 predicts the temperature of the toner image P on the basis of the gloss detected by the gloss sensor 40 in step S2 (step S3).

The gloss correcting unit 50 determines whether the prediction temperature of the toner image P is equal to or less than a predetermined threshold temperature (10° C. or the like) (step S4). In the case where it is determined that the prediction temperature of the toner image P is equal to or less than a predetermined threshold temperature in step S4 (in the case of YES determination in step S4), the gloss correcting unit 50 employs the gloss detected by the gloss sensor 40 in step S2 as it is without correcting the gloss (step S5).

On the other hand, in the case where it is determined that the prediction temperature of the toner image P is higher than the predetermined threshold (in the case of NO determination in step S4), the gloss correcting unit 50 corrects the gloss of the toner image P detected in step S2 in accordance with the temperature of the toner image P predicted in step S3 (step S6). After the process of step S6, the control unit 10 in the image forming device 1 finishes the gloss detecting process.

In the above-described embodiment, in a situation that the temperature of the toner image P fixed on the sheet Sh is assumed to be higher than the predetermined threshold temperature, that is, in the case where the temperature of the toner image P predicted on the basis of the detection value of the gloss sensor 40 is higher than the predetermined threshold temperature, the gloss correcting unit 50 corrects the detection value (gloss) of the gloss sensor 40. Consequently, according to the embodiment, also in the case where gloss different from the gloss to be detected is detected due to the fact that the toner image P on the sheet Sh passed through the fixing unit 36 is not sufficiently cooled, the image forming device 1 can detect the gloss almost the same as that detected in a state where the toner state is stable.

### Various Modifications

The present invention is not limited to the foregoing embodiment but other various applications and modifications can be obviously employed as long as they do not depart from the gist of the present invention described in the scope of claims.

### Modification 1

For example, although the example that the gloss correcting unit 50 corrects gloss by using the temperature of the toner image P predicted from the detection value of the gloss sensor 40 has been described in the foregoing embodiment, the present invention is not limited to the example. A thermometer may be provided in the image forming device 1, for example, near the gloss sensor 40 and the gloss correcting unit 50 may correct the gloss on the basis of the temperature of the toner image P actually measured by the thermometer.

### Modification 2

Although the example that the gloss correcting unit 50 corrects the detection value of the gloss sensor 40 on the basis of the prediction temperature of the toner image P (or temperature actually measured by a thermometer) has been described in the foregoing embodiment, the present invention is not limited to the example. The gloss correcting unit 50 may correct the detection value of the gloss sensor 40 on the basis of fixing temperature in the fixing unit 36 and/or information of elapse time after passage through the fixing unit 36.

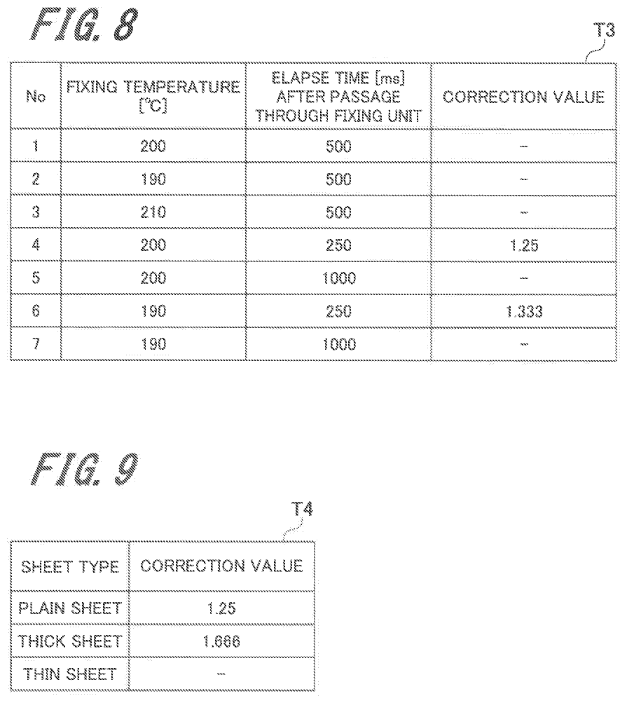

FIG. 8 is a diagram illustrating a configuration example of the fixing temperature-elapse time-correction value table T3 in which the fixing temperature in the fixing unit 36 and elapse time after passage through the fixing unit 36 and the correction value are associated. The fixing temperature-elapse time-correction value table T3 is stored in, for example, the storing unit 14 (refer to FIG. 3) in the image forming device 1 or the like.

As illustrated in FIG. 8, the fixing temperature-elapse time-correction value table T3 has fields of “No.”, “fixing temperature [° C.]”, “elapse time after passage through the fixing unit [ms]”, and “correction value”.

In the field of “No.”, serial numbers assigned to records constructing the fixing temperature-elapse time-correction value table T3 are stored. In the field of “fixing temperature [° C.]”, fixing temperature in the fixing unit 36 is stored. The fixing temperature in the fixing unit 36 is, for example, surface temperature of a heating roller (not illustrated) of the fixing unit 36, which is measured by a not-illustrated temperature sensor or the like disposed near the fixing unit 36. Alternatively, it may be setting temperature of the heating roller of the fixing unit 36.

As the “elapse time after passage through the fixing unit [ms]”, elapse time since the time point when the sheet Sh on which the toner image P is printed passes through the fixing unit 36 (the time point when the fixing process by the fixing unit 36 is performed) is stored. The elapse time after passage through the fixing unit may be elapse time since detection of the sheet Sh by a not-illustrated passing sheet sensor, which is actually measured by a not-illustrated timer or elapse time after passage through the fixing unit 36, which is calculated on the basis of a sheet carriage speed mode (high speed, low speed, or the like) which is set.

In the field of “correction value”, the coefficient (correction value) which is multiplied by the detection value of the gloss sensor 40 is stored.

In the record of No. 1, parameters of “fixing temperature” and “elapse time after passage through the fixing unit” which do not have to be corrected by the gloss correcting unit 50 are indicated. In the modification, it is assumed that the real gloss is detected by the gloss sensor 40 in the case where “fixing temperature” is “200° C.” and “elapse time after passage through the fixing unit” is “500 ms”. Therefore, in the record of No. 1 in which “fixing temperature” is “200° C.” and “elapse time after passage through the fixing unit” is “500 ms”, a correction value is not set.

In the record of No. 2, a pattern that “fixing temperature” is “190° C.” and “elapse time after passage through the fixing unit” is “500 ms” is illustrated. In the example illustrated in the record of No. 2, the fixing temperature is 190° C. which is lower than the normal temperature “200° C.” but elapse time after passage through the fixing unit is “500 ms”, and “500 ms” is considered as time enough to cool the sheet Sh. Under the conditions indicated in the record of No. 2, the gloss detected by the gloss sensor 40 is lower than that detected under the conditions indicated in the record of No. 1. However, the decrease in the gloss is due to the fact that the fixing temperature of the fixing unit 36 is low but is not due to the fact that the sheet Sh is not cooled sufficiently. Therefore, in the record of No. 2, no correction value is set.

In the record of No. 3, a pattern that “fixing temperature” is “210° C.” and “elapse time after passage through the fixing unit” is “500 ms” is illustrated. In the example illustrated in the record of No. 3, the fixing temperature is 210° C. which is higher than the normal temperature “200° C.” and elapse time after passage through the fixing unit is “500 ms”, and time enough to cool the sheet Sh elapses. Under the conditions indicated in the record of No. 3, the gloss detected by the gloss sensor 40 is higher than that detected under the conditions indicated in the record of No. 1. However, the increase in the gloss is due to the fact that the fixing temperature of the fixing unit 36 is high, so that correction of gloss is not necessary. Therefore, in the record of No. 3, no correction value is set.

In the record of No. 4, a pattern that “fixing temperature” is “200° C.” and “elapse time after passage through the fixing unit” is “250 ms” is illustrated. Specifically, in the example illustrated in the record of No. 4, the fixing temperature is 200° C. which is the same as the normal temperature and elapse time after passage through the fixing unit is “250 ms” which is shorter than the normal time “500 ms”. It is assumed that the temperature of the toner image P whose gloss is measured by the gloss sensor 40 under the conditions indicated in the record of No. 4 does not sufficiently decrease. That is, it is considered that the gloss detected by the gloss sensor 40 becomes lower than the gloss to be detected. Therefore, in the record of No. 4, the correction value “1.25” for correcting the detection value of the gloss sensor 40 to be higher is stored.

In the record of No. 5, a pattern that “fixing temperature” is “200° C.” and “elapse time after passage through the fixing unit” is “1000 ms” is illustrated. That is, in the example illustrated in the record of No. 5, the fixing temperature is 200° C. which is the same as the normal temperature but elapse time after passage through the fixing unit is “1000 ms” which is longer than the normal time “500 ms”. Under the conditions indicated in the record of No. 5, it is assumed that the temperature of the toner image P whose gloss is measured by the gloss sensor 40 decreases sufficiently. That is, it is considered that the gloss detected by the gloss sensor 40 becomes gloss to be detected. Therefore, no correction value is set in the record of No. 5.

In the record of No. 6, a pattern that “fixing temperature” is “190° C.” and “elapse time after passage through the fixing unit” is “250 ms” is illustrated. Specifically, in the example illustrated in the record of No. 6, the fixing temperature is 190° C. which is lower than the normal temperature, and elapse time after passage through the fixing unit is “250 ms” which is shorter than the normal time “500 ms”. It is assumed that the temperature of the toner image P whose gloss is measured by the gloss sensor 40 under the conditions indicated in the record of No. 6 does not sufficiently decrease. That is, it is considered that the gloss detected by the gloss sensor 40 becomes lower than the gloss to be detected. Therefore, in the record of No. 6, the correction value “1.333” for correcting the detection value of the gloss sensor 40 to be higher is stored.

In the record of No. 7, a pattern that “fixing temperature” is “190° C.” and “elapse time after passage through the fixing unit” is “1000 ms” is illustrated. That is, in the example illustrated in the record of No. 7, the fixing temperature is 190° C. which is lower than the normal temperature but elapse time after passage through the fixing unit is “1000 ms” which is longer than the normal time “500 ms”. Under the conditions indicated in the record of No. 7, it is assumed that the temperature of the toner image P whose gloss is measured by the gloss sensor 40 decreases sufficiently. That is, it is considered that the gloss of the gloss sensor 40 is lower than the gloss detected under the conditions of No. 1 but becomes gloss to be detected. Therefore, no correction value is set in the record of No. 7.

By the control according to Modification 2, also in the case where the gloss sensor 40 can be installed only in a position where the temperature of the toner image P subjected to fixing does not becomes a predetermined threshold temperature or less (for example, near the fixing unit 36), the image forming device 1 can detect the gloss of the toner image P to be detected.

### Modification 3

The gloss correcting unit 50 may correct the detection value of the gloss sensor 40 in accordance with the kind (sheet type) of the sheet Sh. FIG. 9 is a diagram illustrating a configuration example of a sheet type-correction value table T4 in which sheet type and a correction value are associated. The sheet type-correction value table T4 is stored in, for example, the storing unit 14 (refer to FIG. 3) of the image forming device 1.

As illustrated in FIG. 9, the sheet type-correction value table T4 has fields of “sheet type” and “correction value”. In the field of “sheet type”, the type of the sheet Sh is stored. In the example illustrated in FIG. 9, three kinds of sheet types of “plain sheet”, “thick sheet”, and “thin sheet” are stored. The example illustrated in FIG. 9 is just an example. In the fields of “sheet types” in the sheet type-correction value table T4, sheet types other than the above-described sheet types may be stored.

In the field of “correction value”, the coefficient (correction value) multiplied by the detection value of the gloss sensor 40 is stored.

In the example illustrated in FIG. 9, “1.25” as “correction value” is associated with “plain sheet” of “sheet type”, and “1.666” as “correction value” is associated with “thick sheet” of “sheet type”. No correction value is not associated with “thin sheet” of “sheet type”.

In the case where “sheet type” is “thin sheet”, since heat applied to the sheet Sh by the fixing process decreases fast, it is assumed that the temperature of the toner image P at the time point of detection of the gloss by the gloss sensor 40 is sufficiently low. Therefore, in the sheet type-correction value table T4, no correction value is set for “thin sheet” of “sheet type”.

In the case where “sheet type” is “plain sheet”, the speed that the heat applied to the sheet Sh by the fixing process decreases is slower than that in the case where the sheet type is “thin sheet”. Therefore, it is assumed that the temperature of the toner image P at the time of detection of the gloss by the gloss sensor 40 is not sufficiently low. In the sheet type-correction value table T4, consequently, “1.25” as the correction value is associated with “plain sheet” of “sheet type”.

In the case where “sheet type” is “thick sheet”, the speed that the heat applied to the sheet Sh by the fixing process decreases is slower than that in the case where the sheet type is “plain sheet”. Therefore, it is assumed that the temperature of the toner image P at the time of detection of the gloss by the gloss sensor 40 is not sufficiently low. Therefore, in the sheet type-correction value table T4, “1.666” as the correction value is associated with “thick sheet” of “sheet type”.

By performing the control according to Modification 3, also in the case where the types of the sheet Sh on which the toner image P is formed by the image forming device 1 are various, the image forming device 1 can detect the real gloss of the toner image P according to the type of the sheet Sh.

### Modification 4

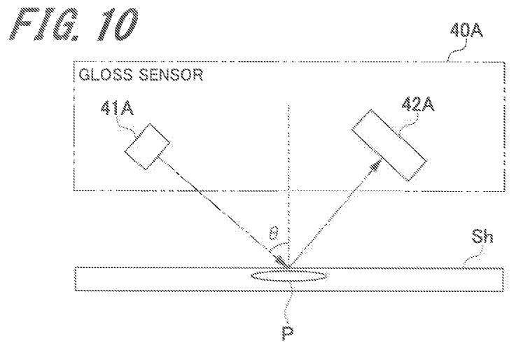

The photosensitive element of the gloss sensor may be a linear sensor in which a plurality of PDs are disposed in lines. FIG. 10 is a diagram illustrating a configuration example of a gloss sensor in which a photosensitive element is a linear sensor. As illustrated in FIG. 10, a gloss sensor 40A includes a light source 41A and a photosensitive element 42A. In a manner similar to the gloss sensor 40 illustrated in FIG. 4, the light source 41A is made by, for example, an LED or the like and irradiates the toner image P formed on the surface of the sheet Sh with light. The photosensitive element 42A is made by a line sensor, receives reflection light emitted from the light source 41A and reflected by the sheet Sh, and calculates an amount of light received (mirror reflectance) and a diffusion distribution of the light amount. A not-illustrated computing unit calculates the gloss on the basis of the light amount of the reflection light received by the photosensitive element 42A and the diffusion distribution of the light amount.

FIG. 11 is a graph illustrating correspondence between reflectance of reflection light and detection angle detected by the photosensitive element 42A of the gloss sensor 40A. The vertical axis of the graph illustrated in FIG. 11 indicates reflectance [%], and the horizontal axis indicates detection angle [° C.]. The horizontal axis of FIG. 11 indicates the distribution of detection angle of reflection light detected by each of a plurality of PDs of the line sensor arranged in lines. In the modification, the photosensitive element 42A detects the peak value of reflectance and a diffusion angle of detection angle of the half value of the reflectance.

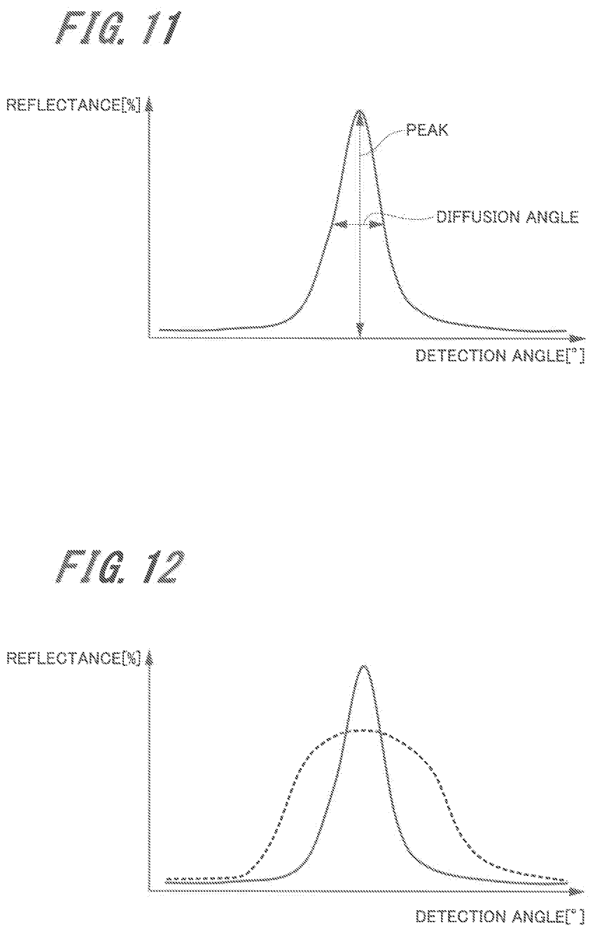

FIG. 12 is a diagram illustrating correspondence between the reflectance of the reflection light detected by the photosensitive element 42A and detection angle in the case where toner image temperature varies. The vertical and horizontal axes of the graph illustrated in FIG. 12 are the same as those in the graph illustrated in FIG. 11. In FIG. 12, the broken line indicates the reflectance and the diffusion distribution of reflection light of a toner image on the sheet Sh immediately after passage through the fixing unit 36 and not cooled sufficiently, and the solid line indicates the reflectance and the diffusion distribution of reflection light of a toner image on the sheet Sh which is sufficiently cooled.

In the case where the sheet Sh is not cooled sufficiently, the toner state is not stable. Consequently, as illustrated in the graph of the broken line, the reflectance of reflection light of a toner image is low, and the diffusion distribution is large. That is, the peak value of the reflectance of reflection light detected by the photosensitive element 42A becomes small, and the diffusion angle of detection angle becomes wide. On the other hand, when the sheet Sh is cooled sufficiently, as illustrated by the graph of the solid line, the reflectance of the reflection light of a toner image becomes high, and the diffusion distribution becomes smaller. That is, the peak value of the reflectance of reflection light of a toner image becomes large, and the diffusion angle of the detection angle becomes narrow. In the modification, in the case where the peak value of the reflectance of reflection light detected by the gloss sensor 40A and the diffusion angle are values detected in a state where cooling is not sufficiently performed, the gloss correcting unit 50 corrects the detection value of the gloss sensor 40A.

In Modification 4, the example that the gloss correcting unit 50 corrects the gloss on the basis of both of the peak value and the diffusion angle detected by the gloss sensor 40A. However, the present invention is not limited to the example. The correction by the gloss correcting unit 50 may be performed on the basis of any one of the peak value and the diffusion angle. Although the example that the photosensitive element of the gloss sensor is configured by a linear sensor has been described in Modification 4, the photosensitive element of the gloss sensor may be configured by a secondary sensor or the like.

### Configuration of Reflectance-Toner Image Prediction Temperature Table

Referring now to FIG. 13, the configuration of a detection value-toner image prediction temperature table T1A which is referred to when the gloss correcting unit 50 corrects the gloss will be described. FIG. 13 is a table illustrating a configuration example of the detection value-toner image prediction temperature table T1A. As illustrated in FIG. 13, the detection value-toner image prediction temperature table T1A has fields of “gloss sensor detection value (reflectance) [%]” and “toner image prediction temperature [° C.]”.

The field of “gloss sensor detection value (reflectance) [%]” has sub-fields of “peak value (%)” and “diffusion angle [° ]” as detection values of the gloss sensor 40. In the field of “toner image prediction temperature [° C.]”, the temperature (prediction temperature) of the toner image P predicted on the basis of the reflectance detected by the gloss sensor 40A is stored.

The detection value-toner image prediction temperature table T1A indicates the correspondences of the peak value of the reflectance, the diffusion angle, and the toner image prediction temperature in the case where the peak value of the reflectance detected at the timing when the state (composition) of a toner becomes stable is “5%”, the diffusion angle is “5°”, and the toner image temperature is “10° C.”.

Concretely, as illustrated in the record of the lowest line in the detection value-toner image prediction temperature table T1A, “10° C.” of the toner image prediction temperature is associated with “5%” of the peak value of the detection value of the gloss sensor 40A and “5°” of the diffusion angle.

In the record of the uppermost line in the detection value-toner image prediction temperature table T1A, “50° C.” of the toner image prediction temperature is associated with “3%” of the peak value of the reflectance detected by the gloss sensor 40A and “15°” of the diffusion angle. Further, in the second uppermost record, “30° C.” of the toner image prediction temperature is associated with “4%” of the peak value of the reflectance and “10°” of the diffusion angle.

In the case where the peak value of the reflection light detected by the gloss sensor 40A is “3%” and the diffusion angle is “15%”, the gloss correcting unit 50 predicts that the temperature of the toner image P is “50° C.” on the basis of the detection value-toner image prediction temperature table T1A. In the case where the peak value is “4%” and the diffusion angle is “10%”, the gloss correcting unit 50 predicts that the temperature of the toner image P is “30° C.”. Further, in the case where the peak value is “5%” and the diffusion angle is “5°”, the gloss correcting unit 50 predicts that the temperature of the toner image P is “10° C.”.

### Configuration of Toner Image Prediction Temperature-Correction Value Table

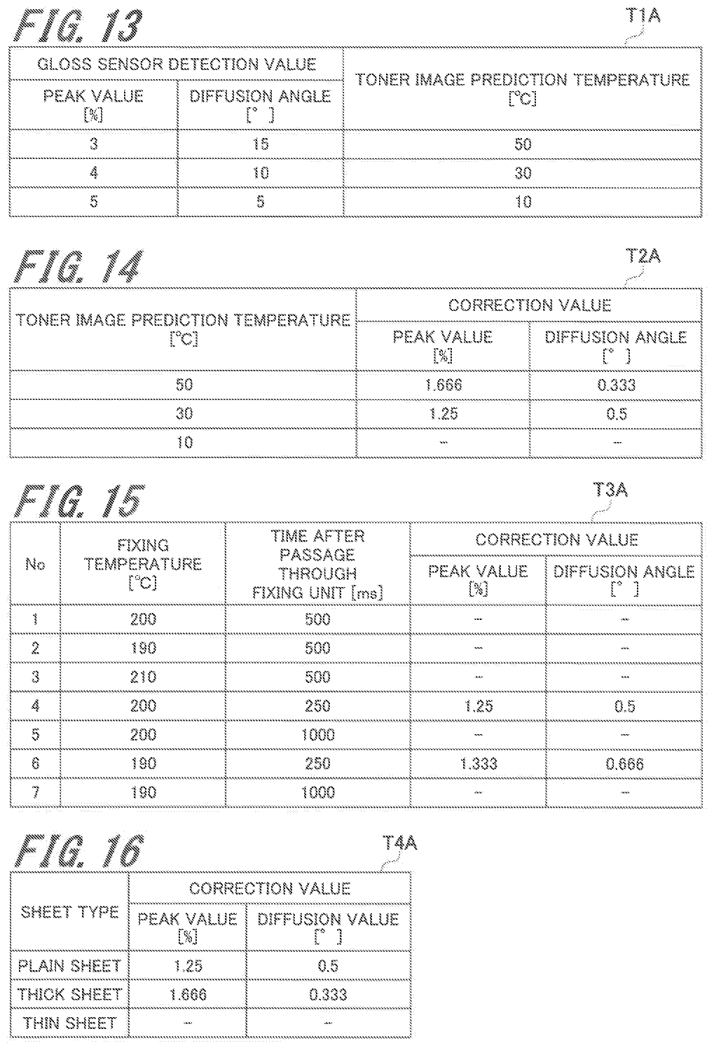

Referring now to FIG. 14, the configuration of a toner image prediction temperature-correction value table T2A which is referred to at the time of correction of gloss by the gloss correcting unit 50 will be described. FIG. 14 is a diagram illustrating a configuration example of the toner image prediction temperature-correction value table T2A.

As illustrated in FIG. 14, the toner image prediction temperature-correction value table T2A has fields of “toner image prediction temperature [° C.]” and “correction value”. In the field of “toner image prediction temperature [° C.]”, the temperature (prediction temperature) of the toner image P predicted on the basis of the reflectance detected by the gloss sensor 40A is stored. In the field of “correction value”, the coefficient (correction value) multiplied by the detection value obtained by the gloss sensor 40 is stored. The field of “correction value” has sub-fields of “peak value (%)” and “diffusion angle [°].

In the toner image prediction temperature-correction value table T2A, “1.666” of the correction value of the peak value and “0.333” of the correction value of the diffusion angle are associated with “50° C.” of “toner image prediction temperature [° C.]”. “1.25” of the correction value of the peak value and “0.5” of the correction value of the diffusion angle are associated with “30° C.” of “toner image prediction temperature [° C.]”. No correction value is associated with “10° C.” of “toner image prediction temperature [° C.]”.

In the case where the temperature of the toner image P is “50° C.”, on the basis of the toner image prediction temperature-correction value table T2A, the gloss correcting unit 50 multiplies “1.666” by the peak value of the reflectance detected by the gloss sensor 40A and multiplies “0.333” by the diffusion angle, thereby correcting the gloss. In the case where the toner image prediction temperature is “30° C.”, the gloss correcting unit 50 multiplies “1.25” by the peak value of the reflectance detected by the gloss sensor 40 and multiplies “0.5” by the diffusion angle, thereby correcting the gloss.

When the above-described correction by the gloss correcting unit 50 is performed, also in the case where the peak value of the reflectance detected by the gloss sensor 40A is low and the diffusion angle is wide due to the fact that the temperature of the sheet Sh after the fixing process is not sufficiently low, the peak value is corrected to be high and the diffusion angle is corrected to be narrow. Therefore, according to Modification 4, the real gloss of the toner image which is detected in a state where the toner state is stable can be detected.

Also in the control according to Modification 4, like in above-described Modification 2, the gloss correcting unit 50 may correct the detection value of the gloss sensor 40 on the basis of fixing temperature in the fixing unit 36 and/or information of elapse time after passage of the fixing unit 36.

FIG. 15 is a diagram illustrating a configuration example of a fixing temperature-elapse time-correction value table T3A. As illustrated in FIG. 15, the fixing temperature-elapse time-correction value table T3A has fields of “No.”, “fixing temperature [C° ], “elapse time after passage of the fixing unit [ms]”, and “correction value”. The field of “correction value” has sub-fields of “peak value [%]” and “diffusion angle [°].

The combinations of the fixing temperature and the elapse time after passage of the fixing unit indicated in No. 1 to No. 7 are the same as those in the fixing temperature-elapse time-correction value table T3 illustrated in FIG. 8.

Also in the fixing temperature-elapse time-correction value table T3A illustrated in FIG. 15, in an example that the fixing temperature illustrated in No. 4 is “200° C.” which is the same as the normal temperature but the elapse time after passage through the fixing unit is “250 ms” which is shorter than the normal elapse time “500 ms”, a correction value is set. Concretely, “1.25” as the coefficient to make the peak value higher is stored as the correction value of the peak value, and “0.5” as the coefficient to make the diffusion angle narrower is stored as the correction value of the diffusion angle.

Also in an example that the fixing temperature illustrated in No. 6 is “190° C.” which is lower than the normal temperature and the elapse time after passage through the fixing unit is “250 ms” which is shorter than the normal elapse time “500 ms”, a correction value is set. Concretely, “1.333” as the coefficient to make the peak value higher is stored as the correction value of the peak value, and “0.666” as the coefficient to make the diffusion angle narrower is stored as the correction value of the diffusion angle. Modification 6 can obtain effects similar to those of Modification 2.

### Modification 5

Also in the control according to Modification 4, as also described in Modification 3, the gloss correcting unit 50 may correct the detection value of the gloss sensor 40A in accordance with the kind (sheet type) of the sheet Sh. FIG. 16 is a diagram illustrating a configuration example of a sheet type-correction value table T4A in which sheet type and a correction value are associated.

As illustrated in FIG. 16, the sheet type-correction value table T4A has fields of “sheet type” and “correction value”. The type of the sheet Sh is stored in the field of “sheet type”, and a coefficient (correction value) multiplied by the detection value of the gloss sensor 40A is stored in the field of “correction value”. The field of “correction value” has sub-fields of “peak value [%]” and “diffusion angle [′]”.

Also in the example illustrated in FIG. 16, correction values are set for “plain sheet” and “thick sheet” of “sheet type”. Concretely, for “plain sheet” of “sheet type”, “1.25” of the correction value of the peak value is associated, and “0.5” of the correction value of the diffusion angle is associated. For “thick sheet” of “sheet type”, “1.666” of the correction value of the peak value is associated, and “0.333” of the correction value for a diffusion angle is associated. Modification 5 can obtain effects similar to those obtained by Modification 3.

In the above-described embodiment or various modifications, by disposing the gloss sensor 40 (or 40A) near the sheet ejection tray 26 (refer to FIG. 2) which is apart from the fixing unit 36, the gloss sensor 40 can detect the gloss of a toner image in a state where the temperature decreases sufficiently. However, the present invention is not limited to the case. A cooling unit such as a cooling fan may be provided just before the gloss sensor 40 in the carriage direction of the sheet Sh. By providing the cooling unit, a toner image whose gloss is detected by the gloss sensor 40 (or 40A) can be cooled sufficiently, so that the gloss sensor 40 (or 40A) can detect the gloss of a toner image whose toner state is reliably stable.

It is also possible to provide a thermometer for detecting the temperature of a toner image and, when it is determined that the temperature of a toner image measured by the thermometer becomes equal to or less than a threshold temperature, perform a control of detecting the gloss by the gloss sensor 40 (or 40A) by the control unit 10 (refer to FIG. 3). By performing such a control, the gloss sensor 40 (or 40A) can detect the gloss of a toner image whose toner state is reliably stable.

In the foregoing embodiment, the example of applying the image forming device of the present invention to the image forming device 1 which is not connected to a post-process device performing post process on the sheet Sh on which a toner image is formed has been described. However, the present invention is not limited to the example. The image forming device of the present invention may be applied to an image forming device to which a post-process device is connected at a post stage. In the case of applying the present invention to such an image forming device, the gloss sensor may be provided in the post-process device, not in the image forming device 1.

Further, in the foregoing embodiment, the configuration of the device (image forming device) is described specifically and concretely for describing the present invention so as to be easily understood. The present invention is not always limited to a device having all of configurations described. The control line and the information line indicated by the solid lines in FIG. 3, which are considered to be necessary for description are illustrated. All of the control line and the information line are not always provided in a product. It may be considered that almost all of the components are connected to one another.

Although the embodiments of the present invention have been described and illustrated above, the disclosed embodiments are made for purposes of illustration and example only and not limitation. The scope of the present invention should be interpreted by the terms of the appended claims.

### DESCRIPTION OF REFERENCE NUMERALS

1 . . . image forming device
10 . . . control unit
30 . . . image forming unit
31 . . . image formation unit
36 . . . fixing unit
40, 40A . . . gloss sensors
41, 41A . . . light sources
42, 42A . . . photosensitive elements
50 . . . gloss correcting unit

What is claimed is:

1. An image forming device comprising:
a gloss sensor irradiating with light, a recording medium on which a toner image is formed and fixed, measuring reflectance of reflection light from the recording medium, and measuring gloss of the toner image on the basis of the reflectance; and
a gloss correcting unit correcting the gloss of the toner image measured by the gloss sensor in a situation that the temperature of the toner image fixed on the recording medium is assumed to be higher than a predetermined threshold temperature or in the case where it is determined that the temperature of the toner image is higher than the predetermined threshold temperature.

2. The image forming device according to claim 1, wherein
the gloss correcting unit predicts temperature of the toner image on the basis of a measurement result of the gloss of the toner image by the gloss sensor, and
a situation that the temperature of the toner image is assumed to be higher than the predetermined threshold temperature is a situation that the predicted temperature of the toner image is higher than the predetermined threshold temperature.

3. The image forming device according to claim 1, further comprising a thermometer measuring temperature of the toner image fixed on the recording medium,
wherein in the case where the temperature of the toner image measured by the thermometer is higher than the predetermined threshold temperature, the gloss correcting unit corrects the gloss of the toner image measured by the gloss sensor.

4. The image forming device according to claim 2, wherein
the gloss correcting unit obtains fixing temperature in a fixing unit for fixing the toner image on the recording medium and elapse time since the recording medium passes through the fixing unit, and
a situation that the temperature of the toner image is assumed to be higher than the predetermined threshold temperature is a situation that the fixing temperature is higher than a predetermined threshold fixing temperature and/or a situation that the elapse time is shorter than predetermined threshold elapse time.

5. The image forming device according to claim 2, wherein the gloss correcting unit obtains a type of the recording medium and, on the basis of the obtained type of the recording medium, corrects a measurement value of the gloss of the toner image by the gloss sensor.

6. The image forming device according to claim 2, further comprising a cooling unit for cooling the recording medium on which the toner image is fixed,
wherein the gloss sensor is disposed downstream of the cooling unit.

7. The image forming device according to claim 3, further comprising a control unit controlling a timing of measuring gloss of the toner image by the gloss sensor,
wherein when it is detected that the temperature of the toner image measured by the thermometer becomes equal to or less than the threshold temperature, the control unit makes the gloss sensor measure the gloss of the toner image.

8. The image forming device according to claim 4, wherein the gloss correcting unit corrects gloss of the toner image by correcting reflectance of reflection light from the recording medium, which is detected by the gloss sensor.

9. The image forming device according to claim 4, wherein the gloss correcting unit corrects gloss of the toner image by correcting a peak value of reflectance of reflection light from the recording medium and the diffusion angle of a diffusion distribution of the reflection light, which is detected by the gloss sensor.

10. The image forming device according to claim 1, wherein the gloss sensor is disposed in a position where temperature of the toner image subjected to the fixing is assumed to be equal to or less than a predetermined threshold temperature.

11. The image forming device according to claim 10, wherein the gloss sensor is disposed near an ejection port from which the recording medium is ejected from the image forming device.

12. The image forming device according to claim 10, wherein the gloss sensor is disposed at a post stage of the image forming device and disposed in a post-process device performing a post process on the recording medium on which the toner image is formed and fixed and which is output from the image forming device.

13. A gloss measuring method by an image forming device having a gloss sensor and a gloss correcting unit, comprising:
a step of causing the gloss sensor to irradiate, with light, a recording medium on which a toner image is formed and fixed, to measure reflectance of reflection light from the recording medium, and to measure gloss of the toner image on the basis of the reflectance; and
a step of causing the gloss correcting unit to correct the gloss of the toner image measured by the gloss sensor, in a situation that the temperature of the toner image fixed on the recording medium is assumed to be higher than a predetermined threshold temperature or in the case where it is determined that the temperature of the toner image is higher than the predetermined threshold temperature.

14. A program executed by an image forming device having a gloss sensor and a gloss correcting unit:
causing the gloss sensor to irradiate with light, a recording medium on which a toner image is formed and fixed, to measure reflectance of reflection light from the recording medium, and to measure gloss of the toner image on the basis of the reflectance; and
causing the gloss correcting unit to correct the gloss of the toner image measured by the gloss sensor, in a situation that the temperature of the toner image fixed on the recording medium is assumed to be higher than a predetermined threshold temperature or in the case where it is determined that the temperature of the toner image is higher than the predetermined threshold temperature.
